(19) United States
(12) Patent Application Publication
(10) Pub. No.: US 2003/0161714 A1
(43) Pub. Date: Aug. 28, 2003

(54) Storage and buffer system with transport elements

(76) Inventors: Jakob Blattner, Ermatingen (CH); Rudy Federici, Berg (CH)

Correspondence Address: VENABLE, BAETJER, HOWARD AND CIVILETTI, LLP, P.O. BOX 34385, WASHINGTON, DC, 20043-9998, US

(21) Appl. No.: 10/332,070

(22) PCT Filed: Jun. 26, 2001
(86) PCT No.: PCT/CH01/00396

(30) Foreign Application Priority Data
Jul. 6, 2000 (CH) 1339/00

(51) Int. Cl. B65G 37/00

(52) U.S. Cl. 414/935; 198/347.1; 198/586

(57) ABSTRACT

The invention relates to a storage and buffer system (12) for connection to transport units for containers, such as for example, cassettes (7), FOUP pods (8), or SMIF boxes for the storage of wafers (9) and similar, comprising a number of conveyor elements (1), arranged along a conveyor line (13), whereby the conveyor elements (1) are arranged in at least one storage line (14), running essentially horizontal, next to, under or over the transport line (13), whilst maintaining a transfer position relative to the adjacent conveyor elements (1). The system further comprise a means of rotation (17) with at least one conveyor element (1), by means of which the containers (7,8) can be transferred in a horizontal direction from the conveyor line (13) to a storage line (14)and a vice versa, or from one storage line to another.

The invention relates—in accordance with the preamble of the independent claim 1—to a storage and buffer system for connection to transport facilities for containers—such as for example cartridges, FOUP pods or SMIF boxes for holding wafers and the like—which comprises a multiplicity of conveyor elements which are arranged along a conveyor line.

During the fabrication of semiconductor elements, such as for example integrated circuits or flat screens, silicon wafers or glass plates are successively processed in a number of different processing installations (such as for example coating, washing or drying installations, etc.). What is important is for it to be impossible for any dust particles or other impurities to be deposited on the cleaned or treated surfaces of the substrates. Defects in the coating of the substrates which are caused by such contamination can lead to relatively large parts of a production batch being scrapped. A contamination-free environment is also considered important for the coating of optical lenses and storage disks for computers, for example.

Processing installations are often positioned in a clean or ultraclean room which is specifically suitable for this purpose and are preferably connected to one another by a transport system which ensures gentle transport of the substrates with little contamination. In such cases, open containers, such as cassettes, racks and the like can be used, in which the substrates are preferably arranged in a horizontal or vertical stack.

However, if the processing installations are in a room which satisfies lower cleanness requirements, they generally have a housing which surrounds an internal clean room. These processing installations too are preferably connected to one another by a transport system which ensures gentle, low-contamination transport of the substrates. In such cases, closed containers, such as FOUP pods (front open unified pods), or SMIF (standard mechanical interface) boxes are used to hold the substrates, such as wafers and the like. In these containers, the substrates are preferably likewise arranged in a horizontal or vertical stack. These containers are known in the prior art and are usually only opened once they are inside a processing installation as a result of a hood being lifted up or a base part being lowered (SMIF) or a side door being moved (FOUP).

The prior art has disclosed transport systems which are marketed under the trade name CLEAN-DRIVE® by the US company Middlesex General Industries, Inc., Woburn, Mass.

In addition, Middlesex General Industries, Inc. markets a transport system under the name ERECT-A-LINE®, which forms the generic prior art. A transport system of this type is basically disclosed by WO-A 99/15445. These are installations which are composed of standardized conveyor elements. These conveyor elements are each mounted in a stationary position and have two longitudinal bars which are arranged substantially parallel and at a distance from one another and on each of which a number of driven or co-rotating rolls are arranged, which rolls each rotate about a substantially horizontal axis, which is at right angles to the bars. These rolls have a substantially common, horizontal upper tangential surface, on which containers of this type—such as for example cassettes, FOUP pods or SMIF boxes for holding substrates, such as wafers and the like—can be placed and can be conveyed by means of frictional driving. Two types of temporary storage systems (buffers) are known in conjunction with the ERECT-A-LINE® transport system: the “hard” buffers and the “soft” buffers. The hard buffers have means which mechanically block further transport of containers which are situated on a conveyor line. While the containers are blocked, the rolls which ensure the frictional drive continue to rotate, and consequently there is a considerable risk of the containers or, if the containers are open, the contents of the containers, being contaminated with particles which are abraded. If the soft buffer is used (soft buffering™, trademark belonging to Middlesex), the driven rolls or conveyor elements are stopped, so that there is no abrasion between the containers and the rolls supporting these containers.

These transport systems have basically proven successful. However, they only have limited storage and buffer systems allowing a relatively large number of containers—such as for example cassettes, FOUP pods or SMIF boxes for holding substrates, such as wafers and the like—to be held without the transport of other containers being adversely affected.

U.S. Pat. No. 5,957,648 has disclosed an automation apparatus for processing, transporting and storing wafer cassettes with two separate loading openings, which are each coupled to a vertical transfer device. A horizontal transfer device is fitted between the two vertical transfer devices.

However, the automation apparatus proposed in U.S. Pat. No. 5,957,648 has a complicated interaction between the two vertical transfer devices and the horizontal transfer device and the two loading openings and also does not utilize the predetermined space very well, with the resultant drawbacks for gentle, low-contamination transport, which the invention aims to improve.

The object of the present invention is to propose an alternative storage system and buffer system which eliminates the problems which are known from the prior art.

This object is achieved by the features of the independent claim 1, which proposes a storage and buffer system for connection to transport facilities for containers—such as for example cassettes, FOUP pods or SMIF boxes for holding wafers and the like—which comprises a multiplicity of conveyor elements which are arranged along a conveyor line. In the storage and buffer system according to the invention, the conveyor elements are arranged in at least one substantially horizontally extending storage line—which extends next to, above or below the conveyor line of the transport facility—so as to maintain a transfer position with respect to the next conveyor elements. It comprises a plurality of storage lines which are arranged in a horizontal register. Furthermore, according to the invention, it comprises rotation means with at least one conveyor element, by means of which the containers can be transferred in the horizontal direction from the conveyor line to a storage line and vice versa or from one storage line to another. One aspect of the invention proposes a transport facility having a storage and buffer system in accordance with the basic concept of the invention described above, in which the transport facility comprises conveyor elements which are each mounted in a stationary position and have two longitudinal bars, which are arranged substantially parallel to and at a distance from one another and on each of which a number of driven or co-rotating rolls are arranged, which rolls rotate about a substantially horizontal axis, which is at right angles to the bars, and have a substantially common, horizontal upper tangential surface. Furthermore, the invention proposes the use of conveyor elements for constructing a storage and buffer system in accordance with the basic concept of the invention described above, in which the conveyor elements are each mounted in a stationary position and have two longitudinal bars which are arranged substantially parallel to and at a distance from one another and on each of which a number of driven or co-rotating rolls are arranged, which rolls rotate about in each case one substantially horizontal axis, which is at right angles to the bars, and have a substantially common, horizontal upper tangential surface, on which containers—such as for example cassettes, FOUP pods or SMIF boxes for holding wafers and the like—can be placed and can be transported by means of frictional driving.

Further features will emerge from the dependent claims.

The present invention makes it possible in particular to set up a storage and buffer system for connection to transport facilities for containers—such as for example cassettes, FOUP pods, SMIF boxes or reticles for holding wafers and the like—which has the highest possible storage capacity with a minimal demand for space. Moreover, the storage and buffer system according to the invention allows a large number of such containers to be removed from the transport system and transferred back to it at a given time and in any desired number without the transport of other containers being adversely affected.

The invention will now be explained in more detail on the basis of diagrammatic drawings which only illustrate examples and do not restrict the scope of the invention. In the drawings:

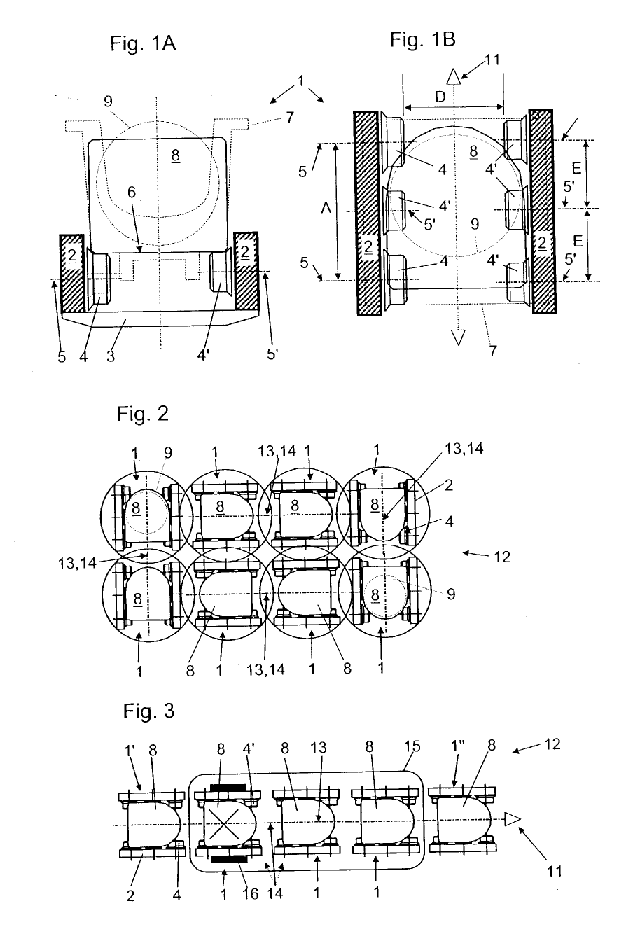

FIG. 1 shows a conveyor element which is known from the prior art produced by US company Middlesex General Industries, Inc., Woburn, Mass., in which FIG. 1A is a vertical partial section and FIG. 1B is a plan view;

FIG. 2 shows a theoretical horizontal register arrangement, in accordance with the invention, of conveyor elements which are arranged so as to maintain a transfer position with respect to one another;

FIG. 3 shows a plan view of a storage system in which a plurality of storage lines—according to one aspect of the invention—are arranged in a vertical register;

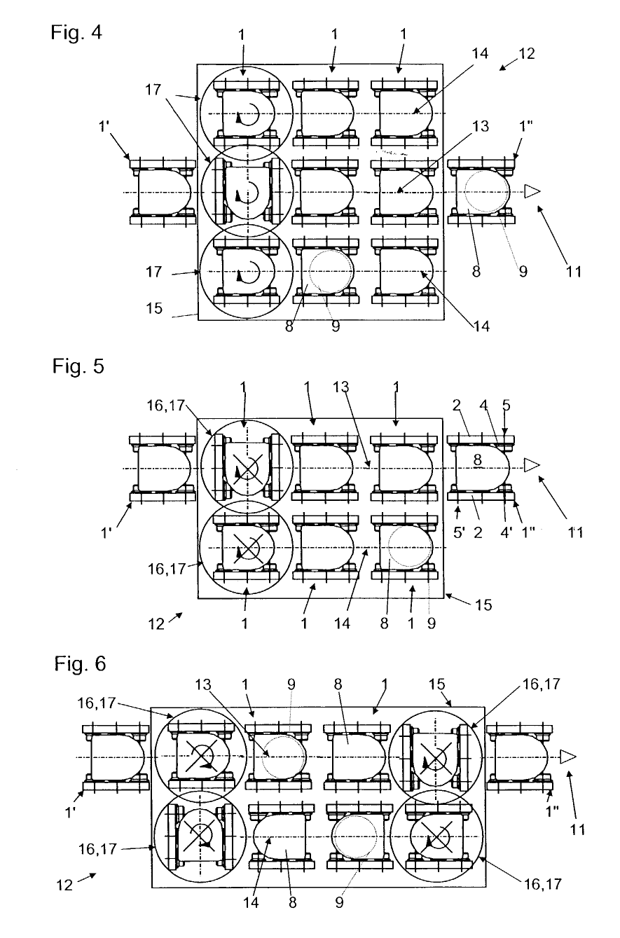

FIG. 4 shows a plan view of a storage and buffer system according to the invention, according to one embodiment, in which a plurality of storage lines are arranged in a horizontal register;

FIG. 5 shows a plan view of a storage and buffer system according to the invention, according to a further embodiment, in which a plurality of storage lines are arranged in a vertical and horizontal register;

FIG. 6 shows a plan view of a storage and buffer system according to the invention, according to a further embodiment.

FIG. 1 shows a conveyor element which is known from the prior art and is marketed by Middlesex General Industries, Inc., Woburn, Mass., USA, under the name ERECT-A-LINE®. FIG. 1A shows a partial vertical section through a conveyor element 1 of this type. Conveyor elements of this type are each mounted in a stationary position and have two longitudinal bars 2 which are arranged substantially parallel to and at a distance from one another. The conveyor elements 1 are preferably secured to a substructure (not shown) by means of a yoke-like component 3 which connects the two longitudinal bars 2. A number of rolls 4, 4′, which can each rotate about a substantially horizontal axis 5, 5′, which is at right angles to the bars 2, are arranged on each of the longitudinal bars 2. These rolls are designed either as driven rolls 4 (resting on a drive shaft 5 and shown with a slightly enlarged diameter) or as co-rotating rolls 4′ (of smaller diameter) and have a substantially common, horizontal upper tangential surface 6. Containers—such as for example cassettes 7, FOUP pods 8 or SMIF boxes for holding wafers 9 and the like′ can be placed on this tangential surface 6 (irrespective of the diameters of the rolls 4, 4′, which may also have dimensions which differ as desired from the present illustration) and can be transported by means of frictional driving.

It is also possible—as can be seen from the publication WO 99/15445 in the name of the applicant Middlesex General Industries, Inc.—for adapter means (not shown) to be used, by means of which the containers 7, 8 can be placed onto the upper tangential surface 6 of the rolls 4, 4′ and transported thereon. These adapter means are preferably designed on one side in such a way that they can reliably accommodate a specific type of container. The adapter means can be clipped, adhesively bonded, screwed or secured in some other way to the containers. On the other side, the adapter means are preferably designed in such a way that they optimally match the upper tangential surface 6 of the rolls 4, 4′ and are guided and transported thereby. As an alternative to WO 99/15445 and as shown in FIG. 1, however, it is also possible for the conveyor elements 1 to be designed in such a way that the containers can be placed directly onto the rolls 4, 4′ and can be guided and transported reliably by the rolls.

In the corresponding plan view (cf. FIG. 1B), it is possible to see the two longitudinal bars 2 of a conveyor element 1, which extend substantially parallel to one another and are arranged at a distance from one another. Two driven rolls 4 and one co-rotating roll 4′ are shown in the drawing on the inner side of the left-hand longitudinal bar 2. Three co-rotating rolls 4′ are indicated on the opposite inner side of the right-hand longitudinal bar 2. It is preferable— in accordance with this illustration in FIG. 1B—for only some of the rolls of an individual longitudinal bar 2 to be motor-driven. The distance between the rolls 4, 4′ is denoted by D. The distance between the driven rolls 4 is denoted by A. The distance between a driven roll and a co-rotating roll or between two co-rotating rolls is denoted by E. The distance D is measured transversely to the conveying direction 11, and the distances A and E are measured parallel to the conveying direction 11. The effective structural width or structural length of these parts to be conveyed required for conveying the containers 7, 8 or adapter means is one criterion for a maximum distance A, which is preferably an integer multiple of E. Especially with automated installations, it is of fundamental importance for the containers 7, 8 or adapter means to rest on at least one driven roll 4 at any time and in any position. It is preferable for the distance A to be approximately ½ of the structural length and the distance D to be approximately 90-95% of the structural width which are effective for the conveying of these parts 7, 8.

A co-rotating roll 4′ arranged opposite a driven roll 4 may be connected to the driven roll via a connecting axle (not shown) so that it likewise becomes a driven roll. For this purpose, the diameters of the two rolls coupled to one another are preferably selected to be identical. Arranging the drives on one side reduces the number of motors required, which is important in particular, for example, with the preferred electrically operated, miniaturized and low-contamination stepper motors. Moreover, the overall structure of the conveyor elements 1 is simplified in this way.

In FIG. 1A, the wafers 9 which are transported and stored in the cassette 7 are shown in a substantially vertical position. The wafers which usually lie substantially horizontally in the FOUP pod 8 are not shown. Conversely, FIG. 1B shows the wafers 9 which usually lie substantially horizontally in the FOUP pod 8, while the wafers which are transported or stored in the cassette 7 are not shown.

FIG. 2 shows a basic horizontal register arrangement, in accordance with the invention, of conveyor elements 1 which are arranged so as to maintain a transfer position with respect to one another and form a storage and buffer system 12. This theoretical arrangement is based on the consideration that each individual conveyor element 1 is arranged with respect to each of its closest neighbors—if appropriate rotated through an angle of rotation which amounts to an integer multiple of 90° (90°, 180°,270°, 360°). This results in the formation of a conveyor line 13 which extends longitudinally (in this case over four conveyor elements) or transversely (in this case over two conveyor elements) as desired. The transfer position between two conveyor elements is always ensured or reached when the longitudinal bars 2 of these conveyor elements 1 are substantially parallel to one another and the distances A or E between the rolls 4, 4′ (parallel to the conveying direction 11) are approximately identical within each conveyor element 1 and also between these two conveyor elements.

A storage and buffer system 12 of this type, the individual components of which are both storage and conveyor elements 1, can be set up without having to fit a robot or similar apparatus. The entire movement space which a robot would require in order to move the containers 7, 8 into the various storage positions can likewise be used as a storage area on account of the inventive arrangement of the storage and conveyor elements 1.

A storage and buffer system 12 of this type, which comprises the same conveyor elements 1 as a transport facility for containers—such as for example cassettes 7, FOUP pods 8 or SMIF boxes for storing wafers 9 and the like—is eminently suitable for connection to transport installations of this type. Because this storage and buffer system 12 in practice does not include any conveyor elements 1 which cannot be used for storage, it forms an extremely compact buffer for temporarily storing corresponding containers which are to be conveyed on transport facilities of this type. The conveyor elements 1 of a storage and buffer system 12 according to the invention extend in at least one substantially horizontally extending storage line 14 which is located next to, above or below the conveyor line 13 of a transport facility.

FIG. 3 shows a plan view of a storage and buffer system in accordance with an aspect of the present invention, in which a plurality of storage lines 14 are arranged in a vertical register. In accordance with the conveying direction 11, the last conveyor element 1′ of the transport system in front of the storage and buffer system 12 and the first conveyor element 1″ of the transport system after the storage and buffer system 12 are also illustrated. The storage and buffer system 12 is preferably accommodated in a housing 15, in order to protect its conveyor elements, the containers and the contents of the latter. The three conveyor elements 1, which are arranged at the same height as the conveyor elements 1′, 1″ of the transport system but inside the housing 15 of the storage and buffer system 12, form the conveyor line 13. The conveyor elements 1 (not shown) which are arranged either above or below the conveyor line 13 form a number of storage lines 14 which all extend substantially horizontally and preferably parallel to the conveyor line 13. The difference in level between the storage lines or between the storage lines 14 next to the conveyor line and the conveyor line 13 is dimensioned in just such a way that a specific choice of containers used, of a very wide range of designs, can pass through without being impeded.

The storage and buffer system 12 comprises a lift means 16 (additionally indicated by a cross) having at least one conveyor element 1. The lift means 16 may comprise any desired conveyor element 1 of the storage and buffer system 12 and preferably does not require significantly more space in the horizontal direction than this very conveyor element 1. The lift means 16 can therefore—in accordance with this first embodiment of the storage and buffer system 12 according to the invention illustrated in FIG. 3—be arranged at three different positions. The containers can be moved in the vertical direction from the conveyor line to a storage line and vice versa or from one storage line to another by the lift means.

FIG. 4 shows a plan view of a storage and buffer system according to the invention, in accordance with an embodiment of the invention, in which a plurality of storage lines are arranged in a horizontal register. In accordance with the conveying direction 11, the last conveyor element 1′ of the transport system ahead of the storage and buffer system 12 and the first conveyor element 1″ of the transport system after the storage and buffer system 12 are also illustrated. The storage and buffer system 12 is preferably accommodated in a housing 15. The three conveyor elements 1, which are arranged at the same height as the conveyor elements 1′, 1″ of the transport system but inside the housing 15 of the storage and buffer system 12, form the conveyor line 13. The conveyor elements 1 which are arranged next to the conveyor line 13 form two storage lines 14 which extend substantially horizontally and preferably parallel to the conveyor line 13.

The storage and buffer system 12 comprises three rotation means 17 (additionally indicated by a rotation arrow) having at least one conveyor element 1. The rotation means 17 may comprise any desired conveyor element 1 of the storage and buffer system 12 and preferably requires no more space in the horizontal direction than this very conveyor element 1. Therefore—in accordance with this embodiment of the storage and buffer system 12 according to the invention which is illustrated in FIG. 4—the rotation means 17 can be arranged at three different positions. The containers can be transferred in the horizontal direction from the conveyor line 13 into a storage line 14 and vice versa or from one storage line to another (in the case of three or more storage lines in a horizontal register; not shown) using the rotation means.

It is preferable for it to be possible to arrange the rotation means in such a way with respect to the conveyor elements 1 next to them that the transfer position can be adopted at an angle of rotation which amounts to an integer multiple of 90°.

FIG. 5 shows a plan view of a storage and buffer system according to the invention, in accordance with a further embodiment of the invention, in which a plurality of storage lines are arranged in a vertical and horizontal register. This embodiment combines the features of the aspects described above and is characterized in that it comprises conveyor elements 1 which are arranged in a component 16, 17 which is simultaneously designed as lift means and as rotation means (and is additionally denoted by a cross and a rotation arrow).

According to this further embodiment (and also in accordance with the designs which have been disclosed above), all the storage lines 14 preferably and substantially extend parallel to the conveyor line 13. It is also preferable for a piece of the conveyor line, all the lift and rotation means and storage lines to be arranged in a common housing 15.

As an alternative to the previous illustrations, the storage and buffer system according to the invention may comprise a multiplicity of conveyor lines 13 and/or storage lines 14 which can cross one another in one plane or at different planes. It is possible to provide a plurality of vertical and/or horizontal registers as described in FIGS. 3 to 5.

Likewise as an alternative to the illustration shown in FIGS. 2 to 5, the rotation angle may also amount, for example, to 60° or may adopt some other suitable value, so that the storage lines may no longer extend parallel to the conveyor line, but rather may extend at an angle of up to 90° with respect to the conveyor line. Forming a tower having a plurality of storage levels and a circular or partially circular basic contour, in which the conveyor elements belonging to one level are arranged in a star shape about a combined lift/rotation means, represents a possible variant of the embodiment shown in FIG. 5 (although this possible variant is not shown). The space at corner positions of transport facilities for containers—such as for example cassettes, FOUP pods or SMIF boxes for storing wafers and the like—is often badly used. A tower of this type makes it possible to set up a storage and buffer system for containers of this type in a space-saving manner in or at such corner positions.

FIG. 6 shows a plan view of a storage and buffer system 12 according to the invention, in accordance with a further embodiment. It is preferable for a rotation means 17 to be arranged at each corner position, so that a type of “roundabout circuit” of the containers 8 within the storage and buffer system becomes possible. Moreover, individual rotation means 17 or a plurality of the rotation means 17 may also be designed as lift means 16, so that maximum mobility of the containers within the storage and buffer system 12 is made possible. It is therefore possible for containers to be rotated through 180° in the horizontal and/or regrouped. The containers can be optimally oriented according to requirements, for example as a result of the FOUP pods being oriented in such a way that their closure doors is directed toward the front or the back in the conveying direction. A storage and buffer system according to this further embodiment can therefore also be used as a central manager of containers, from which containers are released to individual processing stations.

To ensure automated operation of the storage and buffer system according to the invention, the conveyor elements preferably comprise detector means (such as light barriers, bar code readers, electromagnetic and/or electroinductive detection appliances and the like), by means of which the identity and/or the current position of containers 7, 8 and/or adapter means with respect to an individual conveyor element 1 or to the location within a storage line 14 or conveyor line 13 can be detected. This makes it possible to record the individual position, location and orientation of each individual container. It is preferable for the storage and buffer system also to comprise a data-processing installation (not shown) for processing data recorded by the detector means, for processing them and for controlling drives for the motor-driven rolls and lift means and/or rotation means.

If and to the extent that the design of the conveyor elements 1 and of the containers which are to be transported allows, and if the substrates are not adversely affected thereby, it is possible—as an alternative to the above description—for all the conveyor lines 13 and storage lines 14 to deviate from the horizontal position. Identical elements in the figures are always denoted by identical reference symbols.

Further advantages of the storage and buffer systems according to the invention include:

It is possible to propose a new strategy for developing and constructing transport facilities for transporting containers—such as for example a cassette, a FOUP pod or a SMIF box—in which wafers and the like are held, which comprises conveyor elements with two longitudinal bars, which are arranged substantially parallel to and at a distance from one another and on each of which a number of rolls are arranged, which rolls rotate about a substantially horizontal axis, which is at right angles to the bars, and have a substantially common, horizontal upper tangential surface, on which containers—such as for example cassettes, FOUP pods, SMIF boxes or reticles for holding wafers and the like—can be placed and can be transported by means of frictional driving. Transport facilities of this type are characterized in that the conveyor elements are arranged in at least one substantially horizontally extending storage line—which extends next to, above or below the conveyor line of the transport facility—so as to maintain a transfer position with respect to one another.

The same components which are used in the construction of transport facilities can also be used for the construction of a storage and buffer system according to the invention.

1. A storage and buffer system for connection to transport facilities for containers—such as for example cassettes (7) FOUP pods (8) or SMIF boxes for holding wafers (9) and the like—which comprises a multiplicity of conveyor elements (1) which are arranged along a conveyor line (13), in which system
the conveyor elements (1) are arranged in at least one substantially horizontally extending storage line (14)—which extends next to, above and/or below the conveyor line (13) of the transport facility—so as to maintain a transfer position with respect to the next conveyor elements (1),
characterized in that
it comprises at least one storage line (14) which extends next to the conveyor line (13), and
it comprises rotation means (17) with at least one conveyor element (1), by means of which the containers (7, 8) can be transferred in the horizontal direction from the conveyor line (13) to a storage line (14) and vice versa or from one storage line to another.

2. The storage and buffer system as claimed in claim 1, characterized in that it comprises a plurality of storage lines (14), which are arranged in a horizontal register.

3. The storage and buffer system as claimed in claim 1 or 2, characterized in that the system comprises a lift means (16) having at least one conveyor element (1), by means of which the containers (7, 8) can be moved in the vertical direction from the conveyor line (13) into a storage line (14) and vice versa or from one storage line to another, and [lacuna].

4. The storage and buffer system as claimed in one of claims 1 to 3, characterized in that it comprises a plurality of storage lines (14) which are arranged in a vertical register.

5. The storage and buffer system as claimed in one of claims 1 to 4, characterized in that the rotation means (17) can be arranged in such a way with respect to the conveyor elements (1) next to them that the transfer position can be adopted at an angle of rotation which amounts to an integer multiple of 90°.

6. The storage and buffer system as claimed in one of claims 1 to 5, characterized in that at least one of the lift means (16) is simultaneously designed as rotation means (17).

7. The storage and buffer system as claimed in one of the preceding claims, characterized in that all the storage lines (14) extend substantially parallel to the conveyor line (13), and in that a piece of the conveyor line (13), all the lift means (16) and rotation means (17) and storage lines (14) are arranged in a common housing (15).

8. The storage and buffer system as claimed in one of the preceding claims, characterized in that the conveyor elements (1) are each mounted in a fixed position and have two longitudinal bars (2) which are arranged substantially parallel to and at a distance from one another and on each of which a number of driven or co-rotating rolls (4, 4′) are arranged, which rolls rotate about in each case one substantially horizontal axis (5, 5′), which is at right angles to the bars (2), and have a substantially common, horizontal upper tangential surface (6), on which containers (7, 8) of this type can be placed and can be transported by means of frictional driving.

9. The storage and buffer system as claimed in claim 8, characterized in that the storage and buffer system (12) comprises adapter means, by which the containers (7, 8) can be placed onto the upper tangential surface (6) of the rolls (4, 4′) and can be transported thereon.

10. The storage and buffer system as claimed in one of claims 8 or 9, characterized in that the storage and buffer system (12) comprises detector means, by means of which the current position of containers (7, 8) and/or adapter means with respect to an individual conveyor element (1) and/or to the location within a storage line (14) or conveyor line (13) can be recorded.

11. The storage and buffer system as claimed in claim 10, characterized in that the storage and buffer system (12) comprises a data-processing installation for processing data recorded by the detector means, for processing them and for controlling drives for the motor-driven rolls (4) and lift means (16) and/or rotation means (17).

12. A transport facility for transporting containers—such as for example a cassette (7), a FOUP pod (8) or a SMIF box—in which wafers (9) and the like are held, which comprises conveyor elements (1) which are each mounted in a stationary position and have two longitudinal bars (2), which are arranged substantially parallel to and at a distance from one another and on each of which a number of driven or co-rotating rolls (4, 4′) are arranged, which rolls rotate about a substantially horizontal axis (5, 5′), which is at right angles to the bars (2), and have a substantially common, horizontal upper tangential surface (6), characterized in that the transport facility comprises a storage and buffer system (12) as claimed in one or more of claims 1 to 11, in which the conveyor elements (1) are arranged in at least one substantially horizontally extending storage line (14)—which extends next to, above or below the conveyor line (13) of the transport facility—so as to maintain a transfer position with respect to the adjacent conveyor elements (1).

13. The use of conveyor elements (1) for constructing a storage and buffer system (12) as claimed in one or more of claims 1 to 11, in which the conveyor elements (1) are each mounted in a stationary position and have two longitudinal bars (2) which are arranged substantially parallel to and at a distance from one another and on each of which a number of driven or co-rotating rolls (4, 4′) are arranged, which rolls rotate about in each case one substantially horizontal axis (5, 5′), which is at right angles to the bars (2), and have a substantially common, horizontal upper tangential surface (6), on which containers—such as for example cassettes (7), FOUP pods (8) or SMIF boxes for holding wafers (9) and the like—can be placed and can be transported by means of frictional driving.
